(19) United States
(12) Patent Application Publication
(10) Pub. No.: US 2017/0072365 A1
(43) Pub. Date: Mar. 16, 2017

(54) AFTERTREATMENT SYSTEM FOR DIESEL VEHICLE

(71) Applicant: HYUNDAI MOTOR COMPANY, Seoul (KR)

(72) Inventors: Hyo Kyung LEE, Anyang-si (KR); Sang Min LEE, Suwon-si (KR)

(21) Appl. No.: 14/949,859

(22) Filed: Nov. 23, 2015

(30) Foreign Application Priority Data
Sep. 15, 2015 (KR) 10-2015-0130531

(51) Int. Cl. B01D 53/94; F01N 3/08; F01N 3/20

(52) U.S. Cl. CPC B01D 53/9477; F01N 3/2066; F01N 3/0814; B01D 2255/904; B01D 2255/2092; B01D 2255/1021; B01D 2255/1025; B01D 2255/2042; B01D 2255/2065; B01D 2255/106; F01N 2570/14

(57) ABSTRACT

An aftertreatment system for a diesel vehicle includes a lean NOₓ trap (LNT) catalyst, which is installed at a downstream of a diesel engine, absorbs nitrogen oxide (NOₓ) in a lean atmosphere, desorbs nitrogen oxide (NOₓ) in a rich atmosphere based on a lambda window, and converts some of the desorbed nitrogen oxide (NOₓ) to ammonia (NH₃). A selective catalytic reduction (SCR) catalyst is installed at a downstream of the LNT catalyst and purifies nitrogen oxide (NOₓ) that has passed through the LNT catalyst using ammonia (NH₃) generated at the LNT catalyst.

### CROSS REFERENCE TO RELATED APPLICATION

The present application claims the benefit of priority to Korean Patent Application No. 10-2015-0130531, filed Sep. 15, 2015, the entire content of which is incorporated herein for all purposes by this reference.

### TECHNICAL FIELD

The present disclosure relates to an aftertreatment system (ATS) of a diesel vehicle, and more particularly, to an aftertreatment system that maximizes ammonia (NH₃) production yield by generating hydrogen (H₂) gas and that is able to increase the nitrogen oxide (NOₓ) purification performance of a selective catalytic reduction (SCR) catalyst by controlling an oxidation of the produced ammonia (NH₃).

### BACKGROUND

Nitrogen oxide (NOₓ) is harmful emission released from vehicles together with carbon monoxide (CO) and hydrocarbon (HC). When NOₓ is released into the atmosphere, it causes respiratory problems and photochemical smog.

In order to prevent the above problems resulting from nitrogen oxide (NOₓ), regulations have been increasingly strict in restricting the emission of air pollutants.

Along with increasingly stringent vehicle exhaust gas regulations as mentioned above, automobile manufacturers have developed exhaust gas aftertreatment technologies to reduce the emission of nitrogen oxide (NOₓ), which is hard to remove using conventional catalysts.

In particular, although increasing attention has led to the development of lean burn engines in order to improve energy efficiency due to increasing oil price and to reduce carbon dioxide (CO₂) emissions, it is hard to remove nitrogen oxide (NOₓ) from exhaust gas using conventional aftertreatment technology because of a large amount of oxygen in the exhaust gas from lean burn engines.

Accordingly, a selective catalytic reduction (SCR) technology using ammonia (NH₃) and a lean NOₓ trap (LNT) technology have been developed as representative aftertreatment technologies in order to remove nitrogen oxide (NOₓ) generated from lean burn engines.

However, the SCR technology requires an additional device for storing urea and providing it to an SCR catalyst in order to supply ammonia (NH₃) to be used as a reducing agent.

The LNT technology uses a large amount of metals in order to activate a catalyst and requires complicated engine controls.

Accordingly, a three-way catalyst (TWC) converter has been developed to generate ammonia (NH₃) while avoiding large changes to vehicle aftertreatment systems, and developing a passive SCR (pSCR) technology in order to remove nitrogen oxide (NOx) by absorbing it with a LNT catalyst and then converting some of the absorbed nitrogen oxide (NOₓ) to ammonia (NH₃) under a fuel rich condition in which a large amount of hydrogen (H2) gas is generated.

Conventional LNT catalysts include ceria (CeO₂) and complex oxides thereof etc. to increase the storage performance of nitrogen oxide (NOₓ), however, pSCR systems are problematic in that the purification performance thereof is deteriorated due to the conversion of ammonia (NH₃) generated by lattice oxygen existed in ceria to nitrogen (N₂) gas.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and an aspect of the present inventive concept provides an aftertreatment system for a diesel vehicle that is able to increase nitrogen oxide (NOₓ) purification performance by a selective catalytic reduction (SCR) catalyst while preventing oxidation of ammonia (NH₃).

Another aspect of the present inventive concept provides an aftertreatment system for a diesel vehicle that is able to improve the rate of conversion of nitrogen oxide (NOx) to ammonia (NH₃) by generating hydrogen (H₂) gas.

According to an exemplary embodiment in the present disclosure, an aftertreatment system for a diesel vehicle includes a lean NOx trap (LNT) catalyst, installed at a downstream of a diesel engine, absorbing nitrogen oxide (NOₓ) in a lean atmosphere, desorbing nitrogen oxide (NOₓ) in a rich atmosphere based on a lambda window, and converting some of the desorbed nitrogen oxide (NOₓ) to ammonia (NH₃); and a selective catalytic reduction (SCR) catalyst, installed at a downstream of the LNT catalyst, purifying the nitrogen oxide (NO) that passes through the LNT catalyst using ammonia (NH₃) generated at the LNT catalyst.

The LNT catalyst may be alumina (Al₂O₃) coated with a first coating metal selected from the group comprising platinum (Pt), rhodium (Rh), barium oxide (BaO), and mixtures thereof.

The LNT catalyst may not contain a compound oxide including ceria (CeO₂).

The LNT catalyst may convert nitrogen oxide (NOₓ) to ammonia (NH₃) under driving conditions in which the air-fuel equivalence ratio (λ) is less than 1 and a temperature is at least 250° C.

The aftertreatment system may further include a hydrogen catalyst, which is installed at an upstream of the LNT catalyst and generates hydrogen (H₂) gas.

The hydrogen catalyst may be ceria (CeO₂) coated with a second coating metal selected from the group comprising platinum (Pt), aurum (Au), and mixtures thereof.

The hydrogen catalyst may generate hydrogen (H₂) gas using a water gas shift reaction.

The hydrogen catalyst may absorb nitrogen oxide (NOₓ) at a temperature less than 200° C., and may desorb the nitrogen oxide (NOₓ) at a temperature 200° C. or higher.

According to the exemplary embodiment in the present disclosure, it is possible to increase nitrogen oxide (NOₓ) purification performance at a SCR catalyst positioned downstream of a LNT catalyst by preventing the oxidation of ammonia (NH₃) generated at the LNT catalyst.

Further, a hydrogen catalyst upstream of the Lean NOₓ Trap (LNT) catalyst and maximizes the generation of ammonia (NH₃) at the Lean NOₓ Trap (LNT) catalyst by generating hydrogen (H₂) gas through a water gas shift reaction in the hydrogen catalyst, whereby it is able to improve nitrogen oxide (NW purification performance.

The hydrogen catalyst is capable of increasing nitrogen oxide (NOₓ) purification performance by absorbing nitrogen oxide (NOₓ) at low temperatures and desorbing nitrogen oxide (NOₓ) at high temperatures.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a schematic diagram of an aftertreatment system for a diesel vehicle according to an exemplary embodiment in the present disclosure;

FIG. 2 is a graph of an ammonia (NH₃) conversion rate of a Lean NOₓ Trap (LNT) catalyst according to an exemplary embodiment in the present disclosure and comparative examples;

FIG. 3 is a drawing describing a water gas shift reaction at a hydrogen catalyst according to an exemplary embodiment in the present disclosure;

FIG. 4 is a drawing describing the reactions of a hydrogen catalyst and an LNT catalyst according to an exemplary embodiment in the present disclosure;

FIG. 5 is a drawing describing the oxidation of generated ammonia (NH₃); and

FIG. 6 is a graph showing the yield of hydrogen (H₂) gas generated through a water gas shift reaction according to the compositions of hydrogen catalysts according to an exemplary embodiment in the present disclosure.

### DETAILED DESCRIPTION

Herein below, while the invention will be described in detail in conjunction with exemplary embodiments with reference to the accompanying drawings, it will be understood that the present description is not intended to limit the invention(s) to those exemplary embodiments. For reference, the same numerals of the present description indicate substantially the same element, under this rule it is possible to describe by citing something described at other drawings, and it is possible that something repeated or obvious to those skilled in the art is omitted.

The present disclosure has the principle concept of increasing nitrogen oxide (NOₓ) purification performance at a selective catalytic reduction (SCR) catalyst, positioned downstream of a lean NOₓ trap (LNT) catalyst, by preventing the oxidation of the generated ammonia (NH₃) at the LNT catalyst in the case in which a passive-SCR (pSCR) technology is applied to a diesel vehicle.

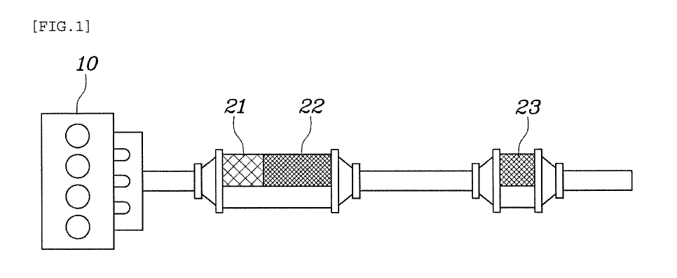

FIG. 1 is a schematic diagram of an aftertreatment system for a diesel vehicle according to an exemplary embodiment in the present disclosure.

As shown in FIG. 1, an aftertreatment system 20 for a diesel vehicle according to an exemplary embodiment has a lean NOₓ trap (LNT) catalyst 22 installed at the downstream of a diesel engine, absorbing or desorbing nitrogen oxide (NOₓ) depending on the temperature, and converting some of the desorbed nitrogen oxide (NOₓ) to ammonia (NH₃). A selective catalytic reduction (SCR) catalyst 23 is sequentially installed at the downstream of the LNT catalyst and purifies nitrogen oxide (NOₓ) using the generated ammonia (NH₃).

The LNT catalyst 22 is an alumina (Al₂O₃) coated with a first coating metal selected from the group comprising platinum (Pt), rhodium (Rh), barium oxide (BaO), and mixtures thereof, and does not contain ceria (CeO₂) in a certain embodiment.

Generally, ceria (CeO₂) is used in a conventional LNT catalyst as an oxygen storage catalyst (OSC) enlarging a lambda window by storing oxygen in a lean atmosphere with a large amount of oxygen and desorbing oxygen in a rich atmosphere with little oxygen. Lattice oxygen present in ceria (CeO₂) oxidizes generated ammonia (NH₃), thereby preventing it from reaching the SCR catalyst and consequently deteriorating nitrogen oxide (NO) purification performance.

TABLE 1

| | Exemplary | Comparative | Comparative |
|---|---|---|---|
| | embodiment | example 1 | example 2 |
| Platinum (Pt) | 0.175 wt % | 0.175 wt % | 0.175 wt % |
| Rhodium (Rh) | 0.355 wt % | 0.355 wt % | 0.355 wt % |
| Barium oxide (BaO) | 15 wt % | 15 wt % | 15 wt % |
| Ceria (CeO₂) | 0 wt % | 25 wt % | 50 wt % |
| Alumina (Al₂O₃) | 84.47 wt % | 59.47 wt % | 34.47 wt % |

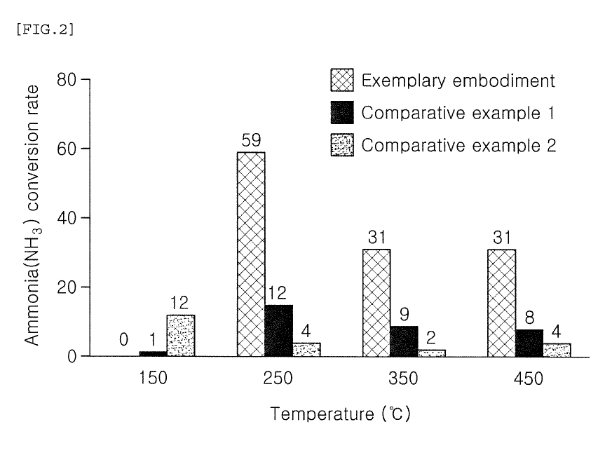

Table 1 illustrates the compositions of an LNT catalyst according to an exemplary embodiment and comparative examples using ceria as a support, and FIG. 2 is a graph showing the ammonia (NH₃) conversion rate of an LNT catalyst according to an exemplary embodiment and comparative examples.

As shown in Table 1 and FIG. 2, although compositions of the first coating metal are the same, when the LNT catalyst includes ceria (CeO₂), it can be known that the yield of the generated ammonia (NH₃) is greatly decreased in comparison to the exemplary embodiment at a high temperature of 250° C. or higher, at which nitrogen oxide (NOx) purification performance is higher at the SCR catalyst 23, installed at the downstream of the LNT catalyst.

The reason for this is that the generated ammonia (NH₃) is oxidized to nitrogen (N₂) gas by the lattice oxygen of ceria (CeO₂). Details are noted below.

Further, the LNT catalyst 22 may convert nitrogen oxide (NOₓ) to ammonia (NH₃) under conditions of an air-fuel equivalence ratio (A) of less than 1 and a high temperature of 250° C. or higher, because the SCR catalyst, positioned downstream of the LNT catalyst, has maximized nitrogen oxide (NOₓ) purification performance at a high temperature of 250° C. or higher.

Accordingly, the LNT catalyst 22 improves nitrogen oxide (NOₓ) purification performance by converting nitrogen oxide (NOₓ) to ammonia (NH₃) at high temperature which has maximized nitrogen oxide (NOₓ) purification performance and providing the SCR catalyst 23 positioned downstream thereof with the ammonia (NH₃).

The aftertreatment system 20 for a diesel vehicle according to an exemplary embodiment may further include a hydrogen catalyst 21, positioned upstream of the LNT catalyst 22 and generating hydrogen (H₂) gas.

The hydrogen catalyst 21 may be ceria (CeO₂) coated with a second coating metal selected from the group comprising platinum (Pt), aurum (Au), and mixtures thereof.

Because a large amount of hydrogen (H₂) gas is necessary to reduce nitrogen oxide (NOₓ), desorbed from the LNT catalyst 22 in a rich atmosphere to ammonia (NH₃), it is possible to maximize the conversion rate of nitrogen oxide (NOₓ) to ammonia (NH₃) at the Lean NOₓ Trap (LNT) catalyst 22 by generating the needed hydrogen (H₂) gas through a water gas shift reaction at the hydrogen catalyst 21.

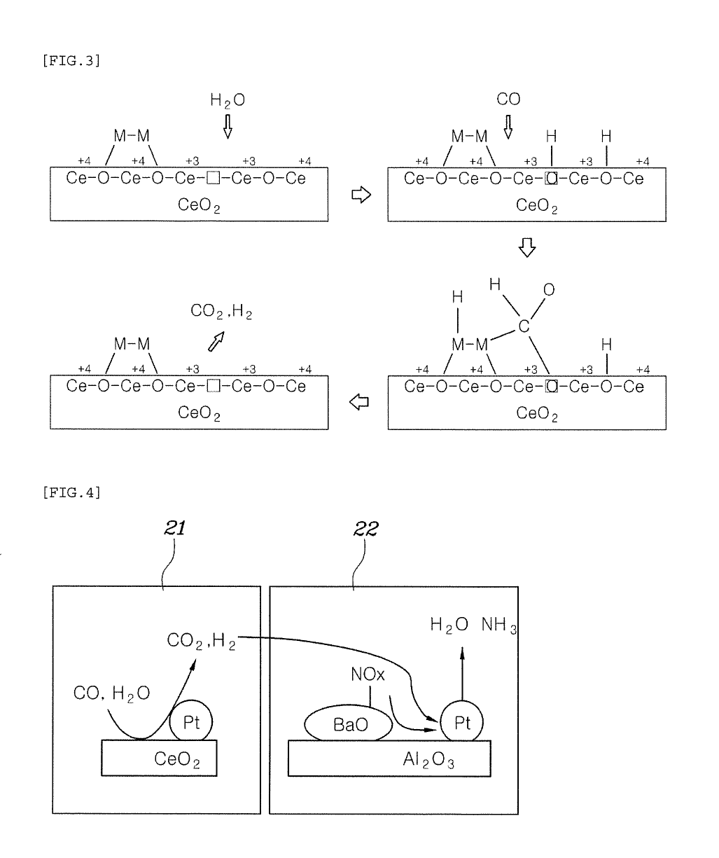

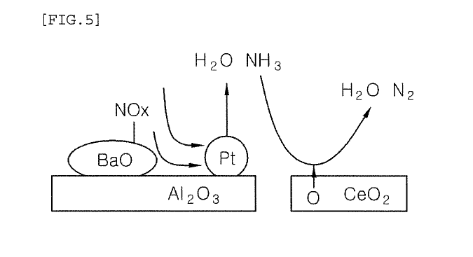

FIG. 3 is a drawing describing a water gas shift reaction at a hydrogen catalyst according to an exemplary embodiment in the present disclosure, and FIG. 4 is a drawing describing reactions of a hydrogen catalyst and an LNT catalyst according to an exemplary embodiment in the present disclosure.

As shown in FIG. 3, when water (H₂O) from the exhaust gas undergoes dissociative absorption on lattice defects of a hydrogen catalyst 21, the absorbed hydrogen (H₂) is rearranged, after which it reacts with carbon monoxide (CO) from the exhaust gas to generate carbon dioxide (CO₂) and hydrogen (H₂) gas.

As shown in FIG. 4, the hydrogen (H₂) gas generated in the above process turns to water (H₂O) and ammonia (NH₃) on the first coating metal coated on the LNT catalyst 22.

FIG. 5 is a drawing describing the oxidation of generated ammonia (NH₃).

As shown in FIG. 5, ammonia (NH₃), generated at the first coating metal coated on the LNT catalyst 22, reacts with lattice oxygen of ceria (CeO₂) and is then reduced to water (H₂O) and nitrogen (N₂) gas.

Accordingly, the hydrogen catalyst 21 may be located at the upstream of the LNT catalyst 22, and for the LNT catalyst 22 to not contain ceria (CeO₂).

Therefore, according to the present disclosure, efficiency of the SCR catalyst 23, installed at the downstream of the LNT catalyst 22, is installed by preventing re-oxidation of the generated ammonia (NH₃).

The LNT catalyst 22 may absorb nitrogen oxide (NOₓ) at a temperature below 200° C. and desorb it at a temperature 200° C. or higher.

The SCR catalyst 23 starts purifying at 200° C. and reaches optimal purification performance at 300° C., and therefore, it is possible to prevent nitrogen oxide (NOₓ) from being released into the air in an unpurified state at a low temperature below 200° C. by making nitrogen oxide (NOₓ) desorbed from the LNT catalyst 22 at a temperature 200° C. or higher at which nitrogen oxide (NOₓ) purification starts.

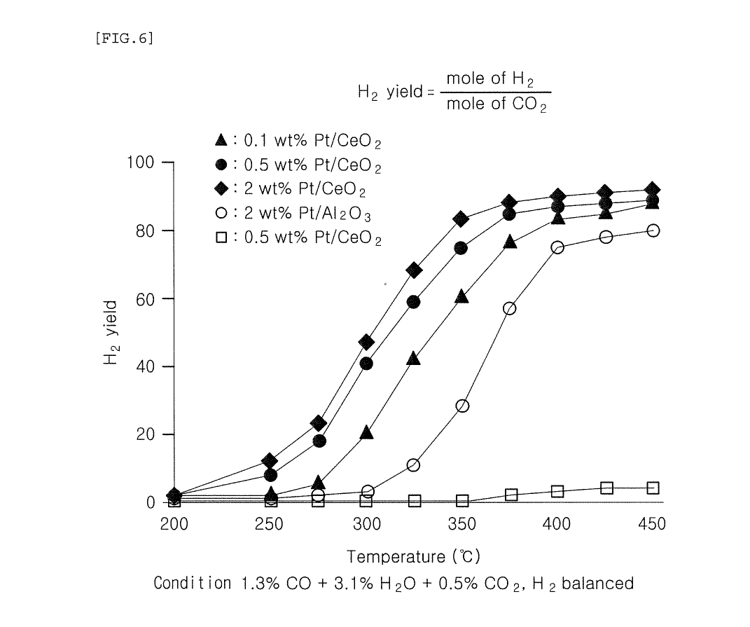

FIG. 6 is a graph showing the yield of hydrogen (H₂) gas, generated through a water gas shift reaction, according to compositions of hydrogen catalysts according to an exemplary embodiment in the present disclosure.

As shown in FIG. 6, it is possible to know that yield of generated hydrogen (H₂) gas increases through the active occurrence of the water gas shift reaction in the case where the second coating metal is applied, in comparison to the case in which it is not applied.

Furthermore, it can be known that the yield of generated hydrogen (H₂) is increased in the case in which ceria (CeO₂) is used as a support, in comparison with the case in which alumina (Al₂O₃) is used.

Accordingly, the hydrogen catalyst 21 may be ceria (CeO₂) coated with a second coating metal selected from the group comprising platinum (Pt), aurum (Au), and mixtures thereof.

Although an embodiment has been described for illustrative purposes, those skilled in the art will appreciate that various modifications, additions, and substitutions are possible, without departing from the scope and spirit of the invention as disclosed in the accompanying claims.

What is claimed is:

1. An aftertreatment system for a diesel vehicle, comprising;
a lean NOₓ trap (LNT) catalyst installed at a downstream of a diesel engine, absorbing nitrogen oxide (NOₓ) in a lean atmosphere, desorbing nitrogen oxide (NOₓ) in a rich atmosphere based on a lambda window, and converting some of the desorbed nitrogen oxide (NOₓ) to ammonia (NH₃); and
a selective catalytic reduction (SCR) catalyst installed at a downstream of the LNT catalyst, purifying nitrogen oxide (NOₓ) that passes through the LNT catalyst using ammonia (NH₃) generated at the LNT catalyst.

2. The aftertreatment system according to claim 1, wherein the LNT catalyst is alumina (Al₂O₃) coated with a first coating metal selected from the group comprising platinum (Pt), rhodium (Rh), barium oxide (BaO), and mixtures thereof.

3. The aftertreatment system according to claim 2, wherein the LNT catalyst does not contain a compound oxide including ceria (CeO₂).

4. The aftertreatment system according to claim 1, wherein the LNT catalyst converts nitrogen oxide (NOₓ) to ammonia (NH₃) under driving conditions in which an air-fuel equivalence ratio (λ) is less than 1 and a temperature is 250° C. or higher.

5. The aftertreatment system according to claim 1, wherein a hydrogen catalyst is positioned upstream of the LNT catalyst and generates hydrogen (H₂) gas.

6. The aftertreatment system according to claim 5, wherein the hydrogen catalyst is ceria (CeO₂) coated with a second coating metal selected from the group comprising platinum (Pt), aurum (Au), and mixtures thereof.

7. The aftertreatment system according to claim 6, wherein the hydrogen catalyst generates hydrogen (H₂) gas using a water gas shift reaction.

8. The aftertreatment system according to claim 6, wherein the hydrogen catalyst absorbs nitrogen oxide (NOₓ) at a temperature less than 200° C. and desorbs the nitrogen oxide (NOₓ) at a temperature 200° C. or higher.
